(19) United States
(12) Patent Application Publication
(10) Pub. No.: US 2025/0383432 A1
(43) Pub. Date: Dec. 18, 2025

(54) SENSOR PROTECTION APPARATUS

(71) Applicants: HYUNDAI MOTOR COMPANY, SEOUL (KR); KIA CORPORATION, SEOUL (KR); DY AUTO CORPORATION, ASAN-SI (KR)

(72) Inventors: Joon Woo Lee, Hwaseong-si (KR); Ju Hong Jeon, Hwaseong-si (KR); Hun Jae Kim, Hwaseong-si (KR); Jin Hyeok Gong, Hwaseong-si (KR); Jeong Goo Lee, Hwaseong-si (KR)

(73) Assignees: HYUNDAI MOTOR COMPANY, SEOUL (KR); KIA CORPORATION, SEOUL (KR); DY AUTO CORPORATION, ASAN-SI (KR)

(21) Appl. No.: 18/951,916

(22) Filed: Nov. 19, 2024

(30) Foreign Application Priority Data
Jun. 18, 2024 (KR) 10-2024-0078734

(51) Int. Cl. G01S 7/497; B60S 1/52; G01S 7/481

(52) U.S. Cl. CPC G01S 7/497; B60S 1/52; G01S 7/4813; G01S 2007/4977

(57) ABSTRACT

A sensor protection apparatus is capable of preventing foreign matter from being directly attached to a sensing surface of a sensor, maintaining cleanliness of the sensing surface, and enabling the sensor to accurately sense without interference even when washed. The sensor protection apparatus includes a housing accommodating a sensor so that a sensing surface of the sensor is exposed, a screen module installed in the housing and having a movable screen located to correspond to the sensing surface of the sensor, and a wiper blade fixedly mounted on the housing, coming into contact with the screen, and wiping the screen when the screen moves.

### CROSS REFERENCE TO RELATED APPLICATIONS

This application claims benefit of priority to Korean Patent Application No. 10-2024-0078734 filed on Jun. 18, 2024 in the Korean Intellectual Property Office, the disclosure of which is incorporated herein by reference in its entirety.

### TECHNICAL FIELD

The present disclosure relates to a sensor protection apparatus capable of preventing foreign matter from being directly attached to a sensing surface of a sensor, maintaining cleanliness of the sensing surface, and enabling the sensor to accurately sense without interference even when washed.

### BACKGROUND

For example, a large number of sensors, such as LiDAR, radar, and camera, are applied to autonomous vehicles to enable safe autonomous driving. However, if the sensors are contaminated with foreign matter, sensing may become inaccurate.

In order to solve the contamination problem, a technology has been proposed to install a pump and a wiper around a sensor of a vehicle and spray air or water to wipe away foreign matter, or to rotate a protective cover of the sensor at high speed to shake off foreign matter.

However, in the case of a sensor with a round shape or at least a curved surface, it may be difficult to clean the sensor cleanly using air or water. In addition, in the case of the technology for rotating the protective cover at high speed, it may be difficult to properly remove foreign matter having high viscosity from the protective cover.

### SUMMARY

An aspect of the present disclosure is to provide a sensor protection apparatus capable of preventing foreign matter from being directly attached to a sensing surface of a sensor, maintaining cleanliness of the sensing surface, and enabling the sensor to accurately sense without interference, even when being washed.

Another aspect of the present disclosure is to provide a sensor protection apparatus capable of preventing secondary contamination of an installation target, such as a vehicle, due to a cleaning liquid used for washing.

According to an aspect of the present disclosure, a sensor protection apparatus includes: a housing accommodating a sensor so that a sensing surface of the sensor is exposed; a screen module installed in the housing and having a movable screen located to correspond to the sensing surface of the sensor; and a wiper blade fixedly mounted on the housing, coming into contact with the screen, and wiping the screen when the screen moves.

The screen module may include a screen formed of a transparent material, a frame supporting the screen, an arm having an end to which the frame is fixed, a rotating shaft coupled to the other end of the arm and being rotatable, and a driving unit connected to the rotating shaft to rotate the rotating shaft.

The frame may include a window connected to the screen and being upright or vertical, an upper plate located at an upper end of the window, and a lower plate located at a lower end of the window, wherein the upper plate may be connected to one end of the arm.

The rotating shaft may be installed upright or vertically in the housing, an upper end of the rotating shaft may be fixedly coupled to the other end of the arm, and the screen may move along an arc-shaped trajectory according to rotation of the rotating shaft.

The housing may include an opening formed in a sidewall, and the screen may have an exposed surface exposed toward the outside of the housing by an amount as large as a size of the opening, and the exposed surface may be located between the sensing surface of the sensor and the opening.

The sensor protection apparatus may further include a controller electrically connected to the driving unit to control the driving unit.

The controller may be electrically connected to the sensor and control an operation of the driving unit according to a result of detecting transparency of the screen by the sensor.

The wiper blade may be mounted to be inserted and replaceable in a mounting groove formed in an inner surface of a sidewall of the housing.

The sensor protection apparatus may further include a nozzle portion formed in the housing above and spraying a cleaning liquid toward a surface of the screen.

The nozzle portion may be formed integrally with a sidewall of the housing, may have a groove shape with an open upper surface and a closed lower surface, and may extend in a height direction in the sidewall.

The nozzle portion may include a plurality of spray holes formed to penetrate through the nozzle portion laterally, and the plurality of spray holes may be aligned in the height direction of the nozzle portion and may be arranged to be spaced apart from each other.

The sensor protection apparatus may further include a first dam and a second dam arranged between the housing and the screen module.

The first dam may include a first waterproof groove protruding downwardly from a bottom surface of the cover constituting the housing and extending in a form of a pair of rails, and a first waterproof wall protruding upwardly from an upper surface of the frame constituting the screen module and extending in a direction matching a movement trajectory of the screen, wherein the first waterproof wall may be at least partially inserted into the first waterproof groove and moves within the first waterproof groove.

The second dam may include a second waterproof groove protruding upwardly from an upper surface of the base constituting the housing and extending in a form of a pair of rails, and a second waterproof wall protruding downwardly from a bottom surface of the frame constituting the screen module and extending in a direction matching a movement trajectory of the screen, wherein the second waterproof wall may be at least partially inserted into the second waterproof groove and move within the second waterproof groove.

The sensor protection apparatus may further include a drain hole formed in the housing to discharge the cleaning liquid remaining in the housing after being sprayed toward a surface of the screen.

### BRIEF DESCRIPTION OF THE FIGURES

The and other aspects, features, and advantages of the present disclosure will be more clearly understood from the following detailed description, taken in conjunction with the accompanying drawings, in which:

FIG. 1 is a perspective view illustrating a sensor protection apparatus according to an embodiment of the present disclosure;

FIG. 2 is a perspective view illustrating the inside of a housing of a sensor protection apparatus according to an embodiment of the present disclosure;

FIG. 3 is a side view of FIG. 2;

FIG. 4 is a partially enlarged view illustrating a wiper blade and a nozzle portion of a sensor protection apparatus according to an embodiment of the present disclosure;

FIG. 5 is a partially enlarged view illustrating a dam and a drain hole of a sensor protection apparatus according to an embodiment of the present disclosure; and

FIG. 6 is a view illustrating an operation of a screen module of a sensor protection apparatus according to an embodiment of the present disclosure.

### DETAILED DESCRIPTION

Hereinafter, the present disclosure is described in detail through drawings. When adding reference numerals to components in each drawing, it should be noted that identical components are given the same reference numerals as much as possible although they are shown in different drawings.

In addition, terms, such as first, second, and third may be used to describe various components, but these components are not limited in order, size, location, or importance by terms, such as first, second, and third and named for the sole purpose of distinguishing one component from another.

In this specification, for the convenience of description, a sensor protection apparatus of the present disclosure is described mainly with an example in which the sensor protection apparatus is installed in a vehicle, but the application examples are not limited thereto.

In addition, the terms “above (up),” “below (down),” “left and right,” etc. used in relation to direction are defined based on a vehicle body, i.e., an installation target.

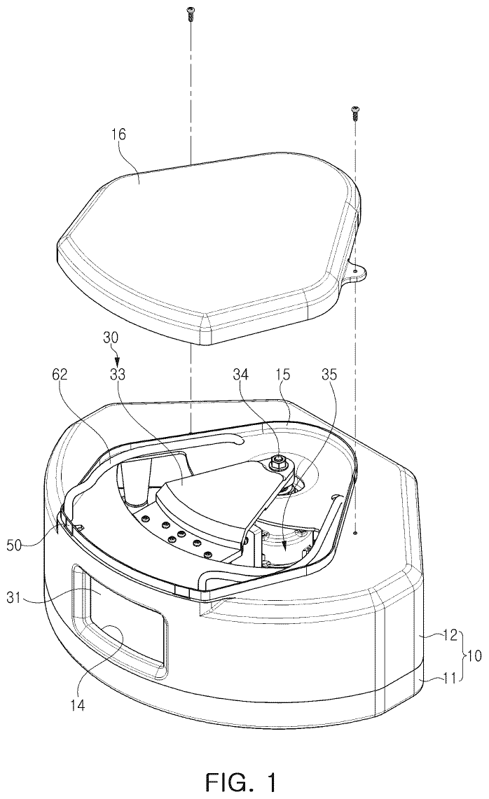

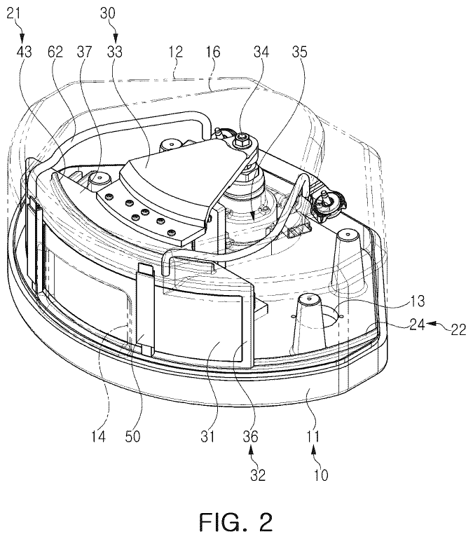

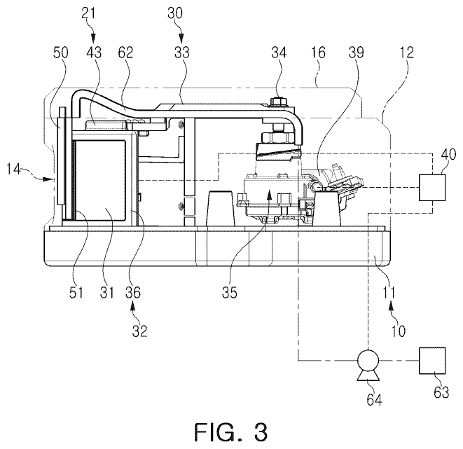

FIG. 1 is a perspective view illustrating a sensor protection apparatus according to an embodiment of the present disclosure. FIG. 2 is a perspective view illustrating the inside of a housing of a sensor protection apparatus according to an embodiment of the present disclosure, and FIG. 3 is a side view of FIG. 2.

The sensor protection apparatus according to an embodiment of the present disclosure may include a housing 10, a screen module 30, and a wiper blade 50.

The housing 10 is a substantially cylindrical member having an internal space, and for example, at least one side of a side surface thereof may be formed as a curved surface, and an opening 14 may be provided on the curved surface. In the drawings, for example, in plan view, the housing has a cross-section having a substantially trapezoidal shape with a curved bottom curve, but the present disclosure is not limited thereto, and the housing may have a cross-sectional shape, such as a circle or an oval.

Such a housing may be fixedly installed on an installation target (not shown). Here, the installation target may be, for example, a vehicle body.

Selectively, the housing 10 may include a base 11 and a cover 12. The base and the cover may be separated from each other vertically and may be coupled to each other by screws, but without being limited thereto, the base and the cover may be coupled by, for example, adhesion or heat fusion.

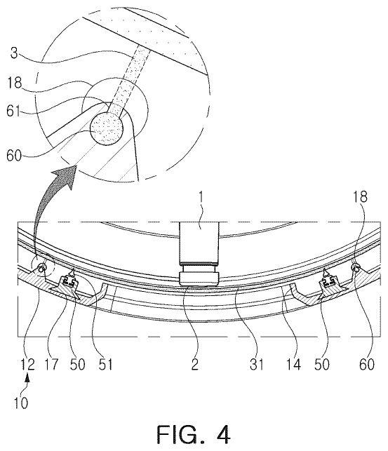

The base 11 may be formed as a plate having a predetermined shape, for example. The base 11 may include a through-hole 13, and power, signals, or cleaning fluid may be provided to the sensor 1 (see FIGS. 4 to 6) and the components of the protection apparatus described below through the through-hole.

The cover 12 may include a sidewall and a ceiling. One side of the sidewall may be formed as a curved surface, and the aforementioned opening 14 may be provided in the curved surface. In addition, an open portion 15 for maintenance may be formed in the ceiling. In this case, the cover may further include a cap 16 for closing the open portion. The cover and the cap may be coupled to each other by screws, but are not limited thereto.

The housing 10 configured in this manner may accommodate the components of the sensor protection apparatus, which are described below, therein, along with the sensor 1. As the sensor, for example, a LiDAR, a radar, a camera, etc. may be employed, but are not limited thereto.

The sensor 1 may be connected to a power source outside the housing 10 by a wire (not shown), or may be connected to a battery located inside the housing to receive power. When the sensor 1 is connected by a wire, the wire may electrically connect the sensor to the power source through the through-hole 13 of the housing.

The screen module 30 may include a screen 31 formed of a transparent material, a frame 32 holding and supporting the screen, an arm 33 having one end to which the frame is fixed, a rotating shaft 34 coupled to the other end of the arm, and a driving unit 35 configured to rotate the rotating shaft.

The screen 31 may be formed of a transparent material enabling sensing of the sensor, while covering the sensing surface 2 of the sensor 1, and may have a curved shape to form a curved surface parallel to the curved surface of the housing 10. The screen may be formed of, for example, transparent glass or transparent synthetic resin.

Here, the transparency of the screen 31 means that, in addition to transmitting light, such as visible light, infrared rays, laser, etc., electromagnetic waves required for sensing may also pass through without reflection or scattering.

The screen 31 may have a length (i.e., a length of an arc of the curved surface) and a height (i.e., a length in a height direction of the housing in the drawings) sufficient to cover the sensing surface 2 of the sensor 1. For example, the length of the screen may have a size twice or more the corresponding length of the opening 14, and the height of the screen may be equal to or slightly greater than the height of the opening.

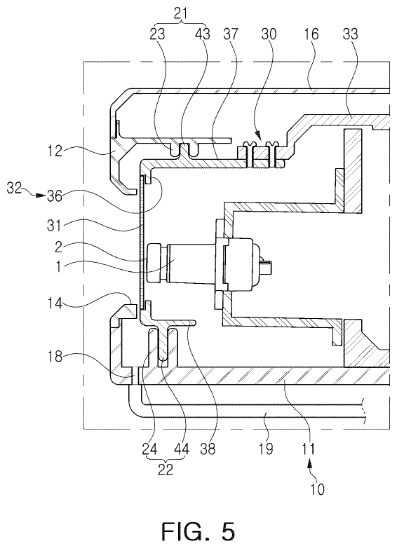

The frame 32 is a member for directly holding and supporting the screen 31 and may have a cross-section having an approximately U-shape. Specifically, the frame may include an upright or vertical window 36, an upper plate 37 located at an upper end of the window, and a lower plate 38 (see FIG. 5) located at a lower end of the window. The window, the upper plate, and the lower plate may be integrally formed.

The window 36 may form an open surface of the frame 32 and may be coupled to the screen, while surrounding the edge of the screen 31. To this end, the window may have a curved shape. For example, the window and the screen may be coupled by an adhesive.

One side of the upper plate 37 may be connected to the upper end of the window 36, and the other side of the upper plate may be connected to one end of the arm 33, so that the frame 32 may be fixed to one end of the arm. One side of the lower plate 38 may be connected to the lower end of the window.

The arm 33 may be formed, for example, as a roughly fan-shaped plate, but is not limited thereto. One end of the arm may be fixedly connected to the upper plate 37 of the frame 32, and the other end thereof may be fixedly connected to an end portion of the rotating shaft 34.

The rotating shaft 34 may be installed upright/vertically on the base 11 of the housing 10, and the other end of the arm 33 may be fixedly coupled to an upper end portion of the rotating shaft and a driving unit 35 may be connected to a middle or lower portion of the rotating shaft 34.

The rotating shaft 34 may be rotated by driving force transmitted from the driving unit 35. Accordingly, the arm 33 fixedly coupled to the rotating shaft, the frame 32 connected to the arm, and the screen 31 supported by the frame may be rotated together in a horizontal direction. By this rotation, the screen may be moved horizontally, i.e., left and right, along an arc-shaped trajectory by a predetermined angular displacement with respect to the housing 10.

The driving unit 35 may include a motor 39, or a motor and a gear unit (not shown), and a motor shaft or a gear shaft may act as an output shaft transmitting driving force. The motor may be, for example, a servo motor or a step motor capable of forward and reverse rotation.

When the driving unit 35 has a gear unit, the gear unit may transmit driving force of the motor 39 to the rotating shaft 34. To this end, the gear unit may include, for example, a worm mounted on the motor shaft of the motor and a worm wheel mounted on the rotating shaft to mesh with the worm, but the configuration of the gear unit is not limited thereto.

Selectively, any other power transmission mechanism, including a belt or chain, may be interposed between the motor shaft of the motor 39 and the rotating shaft, instead of the gear unit. Alternatively, the motor may be directly connected to the rotating shaft.

For example, a motor, such as a stepper motor, capable of rotating the arm 33, the frame 32, and the screen 31 forwardly and backwardly at a predetermined angle and a predetermined speed together with the rotating shaft 34 may be employed. Here, the rotation angle and speed may be adjusted to vary.

The motor 39 of the driving unit 35 may be connected to a power source outside the housing 10 by a wire (not shown), or may be connected to a battery located inside the housing to receive power. When the motor is connected by a wire, the wire may electrically connect the motor and the power source through the through-hole 13 of the housing.

In the sensor protection apparatus according to an embodiment of the present disclosure, since the opening 14 is formed in the housing 10, the screen 31 may be exposed toward the outside of the housing by the size of the opening. In other words, an exposed surface of the screen may be located between the sensing surface 2 of the sensor 1 and the opening of the housing.

When the exposed surface of the screen 31 is contaminated by foreign matter, the screen may be moved by rotating the rotating shaft 34 by the driving unit 35 so that a clean portion of the screen may be located to correspond to the sensing surface 2 of the sensor 1, and at the same time, the contaminated portion of the screen may be washed by the wiper blade 50.

The sensor protection apparatus according to an embodiment of the present disclosure may further include a controller 40 controlling the driving unit 35. The controller may be electrically connected to the driving unit by wired, wireless, or wired/wireless communication. For example, the controller may transmit a control signal to the driving unit through a controller area network (CAN) or local interconnect network (LIN) or may receive a signal from the driving unit.

The controller 40 may include a microprocessor and a memory, etc. The memory may store data for an algorithm for controlling an operation of the driving unit 35, particularly the motor 39, or a program reproducing the algorithm. The microprocessor may perform scheduled control of the driving unit using the data stored in the memory.

The controller 40 may control the driving unit 35 to move the screen 31 to the left or right when a certain condition is achieved (when the transparency of the screen deteriorates or when it rains or snows), so that a clean portion of the screen is located to correspond to the sensing surface 2 of the sensor 1, and at the same time, a contaminated portion of the screen is washed by the wiper blade 50.

For example, the controller 40 may be electrically connected to the sensor 1. Accordingly, when foreign matter is attached to the screen 31, the controller may recognize a sensing abnormality of the sensor, or, if the sensor is a camera, the controller may analyze an image to detect the transparency of the screen and measure a contamination level at the same time. The controller may control the operation of the driving unit 35 according to the result.

Alternatively, the sensor protection apparatus according to an embodiment of the present disclosure may include a transparency detection sensor (not shown) disposed inside the housing 10 and detecting the transparency of the screen 31, and the controller 40 may be electrically connected to the transparency detection sensor.

For example, a light sensor, such as an infrared sensor, or a rain sensor may be employed as the transparency detection sensor. Substantially, the transparency detection sensor detects the transparency of the screen 31, and if it is determined that the transparency of the screen has deteriorated beyond a reference value based on a detection signal from the transparency detection sensor, the controller 40 may control the operation of the driving unit 35.

Accordingly, the clean portion of the screen 31 may be automatically located to correspond to the sensing surface 2 of the sensor 1, and at the same time, the contaminated portion of the screen may be washed by the wiper blade 50.

This controller 40 may be, for example, incorporated into or used in conjunction with an electronic control unit (ECU) of a vehicle when the sensor protection apparatus of the present disclosure is applied to the vehicle.

FIG. 4 is a partially enlarged view illustrating a wiper blade and a nozzle portion of the sensor protection apparatus according to an embodiment of the present disclosure.

As shown in FIGS. 1 to 4, the wiper blade 50 may be fixedly mounted to the housing 10 to be in contact with the screen 31, thereby wiping and washing the screen when the screen is moved.

Specifically, the wiper blade 50 may be inserted into and mounted in a mounting groove 17 formed on an internal surface of a sidewall of the cover 12 in the housing 10. The mounting groove may be formed on both sides of the opening 14 of the housing, adjacent to the opening, and may be arranged to extend in the height direction of the housing. Thus, the wiper blades may be provided as a pair.

The wiper blades 50 may come into contact with the screen 31 and may slide relative to the screen when the screen moves. Specifically, a rubber member 51 constituting the wiper blade may relatively slide, while being in close contact with a surface of the screen opposite to the sensor, to wipe off foreign matter from the surface of the screen.

The sensor protection apparatus according to an embodiment of the present disclosure is configured so that the wiper blade 50 does not rotate and the screen 31 moves, and thus, the wiper blade structurally does not cover the sensing surface 2 of the sensor 1, thereby obtaining an effect of not interfering with the sensing of the sensor, compared to a case in which the wiper blade is configured to move.

In addition, in the sensor protection apparatus according to an embodiment of the present disclosure, since the wiper blade 50 is installed inside the cover 12 of the housing 10, there is no structure of components, such as the wiper blade, protruding to the outside of the housing, and accordingly, the wiper blade may not be damaged by external impact during an assembly process or operation process, thereby improving the durability of the apparatus.

Furthermore, in the sensor protection apparatus according to an embodiment of the present disclosure, since the wiper blade 50 does not protrude to the outside of the housing 10, the volume of the apparatus may be configured to be small, obtaining a secondary effect of improving the assembling efficiency.

The wiper blade 50 may be replaceably mounted in the mounting groove 17 of the housing 10. In particular, when the cover 12 of the housing includes a cap 16, a user may separate the cap from the cover, grip the wiper blade exposed from the open portion 15 of the cover and the mounting groove, and pull it out from the mounting groove in order to replace the worn-out wire blade.

Subsequently, the user may insert a new wiper blade 50 into the mounting groove 17 and couple the cap 16 to the cover 12, thereby completing the replacement of the wiper blade.

In this manner, since the worn-out wiper blade 50 may be separated and removed from the housing 10 at an appropriate time and replaced with a new wiper blade, the advantage of ensuring accurate sensing of the sensor by maintaining a clean screen and sensing surface without lowering the level of cleaning of the screen 31 due to the wiper blade may be obtained.

In addition, the sensor protection apparatus according to an embodiment of the present disclosure may include a nozzle portion 60 provided in the housing 10 to spray a cleaning liquid 3 toward the surface of the screen 31.

Specifically, the nozzle portion 60 may be formed in a generally thin and long cylinder shape with one side open and the other side closed. The nozzle portion may be disposed to be adjacent to the opening 14 of the housing 10 and extend in the height direction of the housing from both sides of the opening. Thus, the nozzle portions may be provided as a pair.

Selectively, the nozzle portion 60 may be formed integrally with the sidewall of the cover 12 of the housing in which the opening 14 is. In this case, the nozzle portion may be formed in a groove shape with an upper surface open and a lower surface closed and extend in the height direction in the sidewall.

The nozzle portion 60 may include a plurality of spray holes 61. The plurality of spray holes may be aligned in the height direction of the nozzle portion and arranged to be spaced apart from each other at regular intervals. Each spray hole may be formed to penetrate through the nozzle portion laterally, thereby allowing the inside and outside of the nozzle portion to communicate with each other.

One end of a supply pipe 62 may be connected to the open side of the nozzle portion 60, and the supply pipe may supply the cleaning fluid 3 to the nozzle portion. The other end of the supply pipe may be connected to a tank 63 through the through-hole 13 of the housing 10. For example, when the installation target is a vehicle body, the nozzle portion may be connected to a washer fluid tank of the vehicle via the supply pipe, and in this case, the nozzle portion may be supplied with a washer fluid of the vehicle as a cleaning fluid.

If necessary, a pump 64 and/or a valve may be installed in the supply pipe 62. As a result, the pump may pump the cleaning fluid 3 from the tank 63 to the nozzle portion 60, and the valve may control or regulate the supply of the cleaning fluid. The pump and/or valve may be electrically connected to the controller 40, so that the supply of the cleaning liquid may be controlled by the controller along with the driving of the driving unit 35.

The cleaning liquid 3 discharged from the plurality of spray holes 61 aligned in the height direction of the nozzle portion 60 may be sprayed in a line shape perpendicular to the surface of the screen 31 opposite to the sensor. As the cleaning liquid is sprayed onto the surface of the screen in this manner, traces remaining on the contaminated portion of the screen or foreign matter having high viscosity and being relatively small or thin may be washed by the cleaning liquid and wiped by the wiper blade.

FIG. 5 is a partially enlarged view illustrating a dam and a drain hole of the sensor protection apparatus according to an embodiment of the present disclosure.

Since the sensor protection apparatus according to an embodiment of the present disclosure sprays the cleaning liquid 3 onto the screen 31 through the spray holes 61 of the nozzle portion 60, a unit for protecting the interior of the housing 10 accommodating the sensor 1 and the driving unit 35 from the introduction of the cleaning liquid or foreign matter is required.

To this end, the sensor protection apparatus according to an embodiment of the present disclosure may include a first dam 21 and a second dam 22 arranged between the housing 10 and the screen module 30.

The first dam 21 may include a first waterproof groove 23 provided in the housing 10 and a first waterproof wall 43 provided in the screen module 30. The second dam 22 may include a second waterproof groove 24 provided in the housing and a second waterproof wall 44 provided in the screen module.

Specifically, the first waterproof groove 23 may be formed as a structure protruding downwardly from a bottom surface of a ceiling of the cover 12 constituting the housing 10 and extending in the form of a pair of rails along the curved surface of the sidewall. For example, when the housing has a cross-sectional shape, such as a circle or an oval, the first waterproof groove may extend in the range of at least 90 degrees along one side of the curved surface.

The first waterproof wall 43 may be formed as a structure in the form of a barrier protruding upwardly from an upper surface of the upper plate 37 of the frame 32 constituting the screen module 30 and extending in a direction matching a movement trajectory of the screen 31. The first waterproof wall may be at least partially inserted into the first waterproof groove 23 and may be moved within the first waterproof groove.

In this manner, the first dam 21 formed by combining the first waterproof wall 43 and the first waterproof groove 23 may have the effect of blocking introduction of the cleaning liquid 3 or foreign matter toward the sensor 1 or the driving unit 35 inside the housing through a gap between the housing and the screen module 30 at least from the periphery of the opening 14 of the housing 10.

In addition, since the first waterproof wall 43 may be moved along the first waterproof groove 23, the first dam 21 may serve as a guide to allow the screen 31 of the screen module 30 to be stably moved along an intended trajectory.

In addition, the second waterproof groove 24 may be formed as a structure protruding upwardly from the upper surface of the base 11 constituting the housing 10 and extending in the form of a pair of rails along the curved surface of the sidewall. For example, when the housing has a cross-sectional shape, such as a circle or an oval, the second waterproof groove may extend in the range of at least 90 degrees along one side of the curved surface.

The second waterproof wall 44 may be formed as a structure in the form of a barrier protruding downwardly from a bottom surface of the lower plate 38 of the frame 32 constituting the screen module 30 and extending in a direction matching a movement trajectory of the screen 31. The second waterproof wall may be at least partially inserted into the second waterproof groove 24 and move within the second waterproof groove.

Accordingly, the second dam 22 formed by combining the second waterproof wall 44 and the second waterproof groove 24 may have the effect of blocking the introduction of the cleaning liquid 3 or foreign matter toward the sensor 1 or the driving unit 35 inside the housing through the gap between the housing and the screen module 30 at least from the periphery of the opening 14 of the housing 10.

In addition, since the second waterproof wall 44 may be moved along the second waterproof groove 24, the second dam 22 may serve as a guide to allow the screen 31 of the screen module 30 to be stably moved along an intended trajectory.

In addition, the sensor protection apparatus according to an embodiment of the present disclosure may include a drain hole 18 provided in the housing 10 to discharge contaminated cleaning liquid 3 remaining in the housing after being sprayed toward the surface of the screen 31.

The drain hole 18 may be formed to penetrate through the base 11 constituting the housing 10. The drain hole may be disposed between the edge at the outer periphery of the base and the second waterproof groove 24. A hose 19 may be connected to the drain hole to collect the contaminated cleaning liquid in an arbitrary storage or discharge the same to the outside of the installation target. Accordingly, there is an advantage in that secondary contamination of the installation target, such as a vehicle, may be prevented.

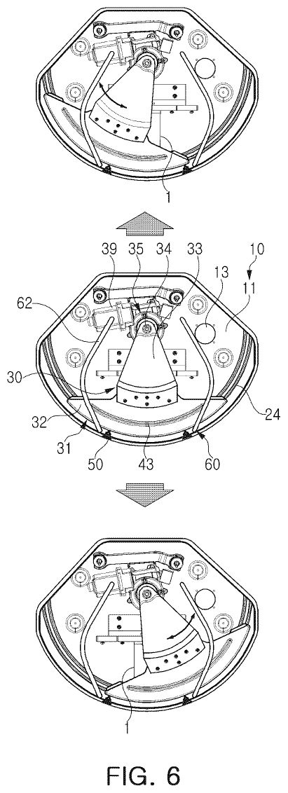

FIG. 6 is a view illustrating an operation of a screen module of the sensor protection apparatus according to an embodiment of the present disclosure.

If foreign matter adheres to the exposed surface of the screen, as described above, the controller 40 may detect a sensing abnormality of the sensor 1 or, if the sensor is a camera, the controller 40 may analyze an image to detect the transparency of the screen 31 and measure a contamination level at the same time. The controller may control the operation of the driving unit 35.

Alternatively, if the transparency detection sensor detects the transparency of the screen 31 and determines that the transparency of the screen has deteriorated beyond the reference value based on a signal from the transparency detection sensor, the controller 40 may control the operation of the driving unit 35.

The rotating shaft 34 may rotate by driving force of the driving unit 35, and accordingly, the arm 33 fixedly coupled to the rotating shaft, the frame 32 connected to the arm, and the screen 31 supported by the frame may rotate together in a horizontal direction. By this rotation, the screen may be moved horizontally, i.e. left and right, by a predetermined angular displacement with respect to the housing 10.

As the screen 31 moves, the foreign matter also moves, and the foreign matter gradually approaches the wiper blade 50 disposed to be adjacent to the opening 14 of the housing 10. Since the rubber member 51 constituting the wiper blade is in close contact with the surface of the screen, the foreign matter on the screen may be removed from the surface of the screen as the fixed wiper blade moves relative to the screen.

At this time, as the screen 31 moves, the initially exposed surface of the screen is separated from the opening 14 of the housing 10, while the clean portion of the screen, which has been away from the opening, may move toward the opening of the housing to be located to correspond to the sensing surface 2 of the sensor 1 to form an exposed surface.

Accordingly, the sensor 1 may continuously and accurately perform sensing through the screen 31 without interruption or suspension even during washing.

Even though foreign matter has been removed from the screen 31, traces may remain or foreign matter having high viscosity and being relatively small or thin may remain, so that there may still be a contaminated portion on the screen.

Under the control of the controller 40, the pump 64 may operate to spray the cleaning liquid 3 from the nozzle portion 60 of the housing 10 toward the surface of the screen 31, and at the same time, the driving unit 35 may operate the other way round from a previous operation, so that the rotating shaft 34 may rotate in the reverse direction and the screen may move toward the original position.

In this manner, the remaining foreign matter or traces may be washed away by the cleaning liquid 3 and wiped away by the rubber member 51 of the wire blade 50. The surface of the screen 31 that has been washed and cleaned may move toward the opening 14 of the housing 10 and is located to correspond to the sensing surface 2 of the sensor 1 and may form an exposed surface again.

This process may be performed at least once. For example, the washing process of the screen 31 may be continuously performed in rainy or snowy weather. Even if the aforementioned process is repeated several times, the sensor 1 may continuously perform accurate sensing through the clean screen 31.

Alternatively, in a case in which the surface of the screen 31 is contaminated to an extent that it is difficult to overcome while the vehicle, which is an installation target, operates, for example, when excessive dust or mud is applied or when an insect collides with the screen, the screen module 30 may be controlled to move only halfway instead of moving back and forth, thereby exposing the uncontaminated clean portion of the screen through the opening 14 of the housing 10. Meanwhile, the user may replace the worn-out wiper blade 50 with a new one at an appropriate time.

As described above, according to an embodiment of the present disclosure, since the screen is configured to surround the sensing surface of the sensor and to be movable, the sensor may be prevented from being contaminated, and even if the screen is contaminated by foreign matter, the screen may be easily and cleanly washed and sensing may be continuously performed without interruption or suspension.

In addition, according to an embodiment of the present disclosure, a two-step system may be applied in which large foreign matter is removed by the wiper blade and small foreign matter having high viscosity and being relatively small may be washed away with a cleaning liquid, so that the effect of removing foreign matter from the screen may be achieved reliably within the shortest time.

In addition, according to an embodiment of the present disclosure, since the cleaning liquid may be discharged through the drain hole of the housing after washing the screen, there is an effect of preventing secondary contamination of an installation target, such as a vehicle.

The description is merely illustrative of the technical idea of the present disclosure, and various modifications and changes may be made by those skilled in the art without departing from the essential characteristics of the present disclosure.

Accordingly, the embodiments disclosed in the present disclosure and the accompanying drawings are not intended to limit the technical idea of the present disclosure but to describe the present disclosure, and the scope of the technical idea of the present disclosure is not limited by the embodiments and the accompanying drawings. The protection scope of the present disclosure should be interpreted by the following claims, and all technical ideas within the equivalent scope should be interpreted as being included in the scope of the present disclosure.

1. A sensor protection apparatus comprising:
a housing accommodating a sensor so that a sensing surface of the sensor is exposed;
a screen module positioned in the housing and having a movable screen positioned adjacent to the sensing surface of the sensor; and
a wiper blade fixedly mounted on the housing, the wiper blade being configured to contact the movable screen, and configured to wipe the movable screen when the movable screen moves.

2. The sensor protection apparatus of claim 1, wherein the screen module includes:
the movable screen formed of a transparent material;
a frame supporting the screen;
an arm having a first end to which the frame is fixed;
a rotating shaft coupled to a second end of the arm and being rotatable; and
a driving unit connected to the rotating shaft and configured to rotate the rotating shaft.

3. The sensor protection apparatus of claim 2, wherein the frame includes:
a window connected to the screen and being positioned vertically;
an upper plate located at an upper end of the window; and
a lower plate located at a lower end of the window;
wherein the upper plate is connected to the first end of the arm.

4. The sensor protection apparatus of claim 2, wherein the rotating shaft is positioned vertically within the housing,
an upper end of the rotating shaft is fixedly coupled to the second end of the arm, and
the screen is configured to move along an arc-shaped trajectory according to rotation of the rotating shaft.

5. The sensor protection apparatus of claim 2, wherein the housing includes an opening formed in a sidewall, and
the screen has an exposed surface exposed toward an outside of the housing and being as large as a size of the opening, and
the exposed surface is located between the sensing surface of the sensor and the opening.

6. The sensor protection apparatus of claim 2, further comprising a controller electrically connected to the driving unit and configured to control the driving unit.

7. The sensor protection apparatus of claim 6, wherein the controller is electrically connected to the sensor and configured to control an operation of the driving unit according to a result of detecting a transparency of the screen by the sensor.

8. The sensor protection apparatus of claim 1, wherein the wiper blade is mounted in a mounting groove formed in an inner surface of a sidewall of the housing.

9. The sensor protection apparatus of claim 1, further comprising a nozzle portion formed in the housing and configured to spray a cleaning liquid toward a surface of the movable screen.

10. The sensor protection apparatus of claim 9, wherein the nozzle portion is formed integrally with a sidewall of the housing, the nozzle portion has a groove shape with an open upper surface and a closed lower surface, and the nozzle portion extends in a height direction in the sidewall.

11. The sensor protection apparatus of claim 10, wherein:
the nozzle portion includes a plurality of spray holes configured to penetrate through the nozzle portion laterally; and
the plurality of spray holes are aligned in a height direction of the nozzle portion, and are arranged spaced apart from each other.

12. The sensor protection apparatus of claim 9, further comprising a first dam and a second dam arranged between the housing and the screen module.

13. The sensor protection apparatus of claim 12, wherein the first dam includes:
a first waterproof groove protruding downwardly from a bottom surface of the cover constituting the housing and extending in a form of a pair of rails; and
a first waterproof wall protruding upwardly from an upper surface of a frame supporting the movable screen constituting the screen module and extending in a direction matching a movement trajectory of the movable screen;
wherein the first waterproof wall is at least partially inserted into the first waterproof groove and is configured to move within the first waterproof groove.

14. The sensor protection apparatus of claim 12, wherein the second dam includes:
a second waterproof groove protruding upwardly from an upper surface of a base constituting the housing and extending in a form of a pair of rails; and
a second waterproof wall protruding downwardly from a bottom surface of a frame supporting the movable screen constituting the screen module and extending in a direction matching a movement trajectory of the movable screen;
wherein the second waterproof wall is at least partially inserted into the second waterproof groove and move within the second waterproof groove.

15. The sensor protection apparatus of claim 9, further comprising a drain hole formed in the housing and configured to discharge the cleaning liquid remaining in the housing after being sprayed toward a surface of the movable screen.
